(19) United States
(12) Patent Application Publication
(10) Pub. No.: US 2007/0277738 A1
(43) Pub. Date: Dec. 6, 2007

(54) PET WATERING DEVICE

(76) Inventor: William M. Dentsbier, Foristell, MO (US)

Correspondence Address: BLACKWELL SANDERS LLP, 720 OLIVE STREET, SUITE 2400, ST. LOUIS, MO, 63101, US

(21) Appl. No.: 11/623,896

(22) Filed: Jan. 17, 2007

Related U.S. Application Data
(60) Provisional application No. 60/793,970, filed on Apr. 21, 2006.

(51) Int. Cl. A01K 7/00

(52) U.S. Cl. 119/77

(57) ABSTRACT

An automatic pet watering device is provided. The watering device includes a storage container with a pair of flow control devices linked together for simultaneous operation where when the filling flow control device is open, the dispensing flow control device is closed and vice versa. A muzzle guard may be provided in a drinking bowl portion of a dispensing tray arrangement.

### CROSS-REFERENCE TO RELATED APPLICATIONS

This application claims the benefit of U.S. Provisional Application Ser. No. 60/793,970, filed Apr. 21, 2006, the disclosure of which is incorporated herein by reference.

### BACKGROUND OF THE INVENTION

Pet watering devices are well known and come in various forms, from a simple dish that may be bottom weighted to prevent turnover to pet activated faucet attachments. One common type of pet watering device is shown in U.S. Pat. No. 6,119,628 and Des. 406,926. This type of watering device uses an inverted removable jar to provide water to a dish. Water is fed out through the inverted mouth of the jar into an upwardly opening dish and automatically maintains the water in the dish at a pre-determined fixed level. Because of the balance of pressures, and the jar being un-vented above the water level in the tray, the water will not drain out of the jar until the water level in the tray is lowered as by pet consumption. This type of automatic water dispenser is well adapted for use, but does present some problems. The main problem with such a watering device is that it requires removal of the jar which then discripts the seal of the jar interior allowing water to run out of the jar until it is reoriented to a position where water cannot run out of the jar neck. The same problem is encountered when the jar is full and trying to be installed on the base. Additionally, some of the jars are large and are quite heavy when full.

Such pet watering devices also present another problem; in particular, dogs tend to wet their muzzle when drinking from such watering devices, particularly when the dog has long muzzle hair. They will then dribble the water or shake it off after drinking.

Thus, there is a need for an improved pet watering device.

### BRIEF DESCRIPTION OF THE DRAWINGS

FIG. 1 is a perspective view of an automatic pet watering device.

FIG. 2 is an exploded view of the pet watering device of FIG. 1.

FIG. 3 is a sectional view of the watering device taken along the line 3-3 of FIG. 1.

FIG. 4 is a sectional view of the watering device similar to FIG. 3, but showing the lid in an open position and a bottom flow control device closed for filling the container. This Figure also shows an alternate embodiment of a bowl insert.

FIG. 5 is a view similar to FIG. 1, but showing an alternate embodiment.

Like numbers throughout the various Figures designate like or similar parts and/or structure.

### DETAILED DESCRIPTION

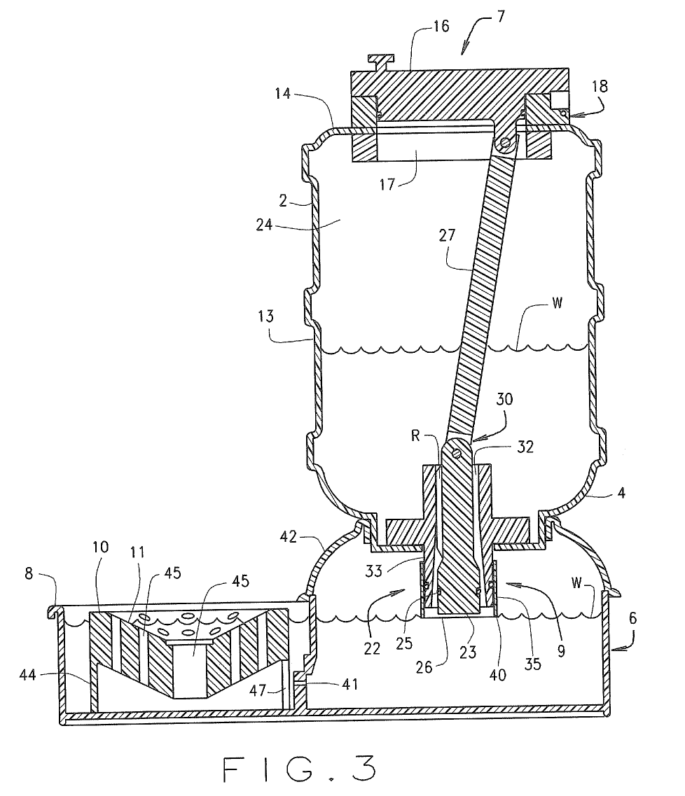

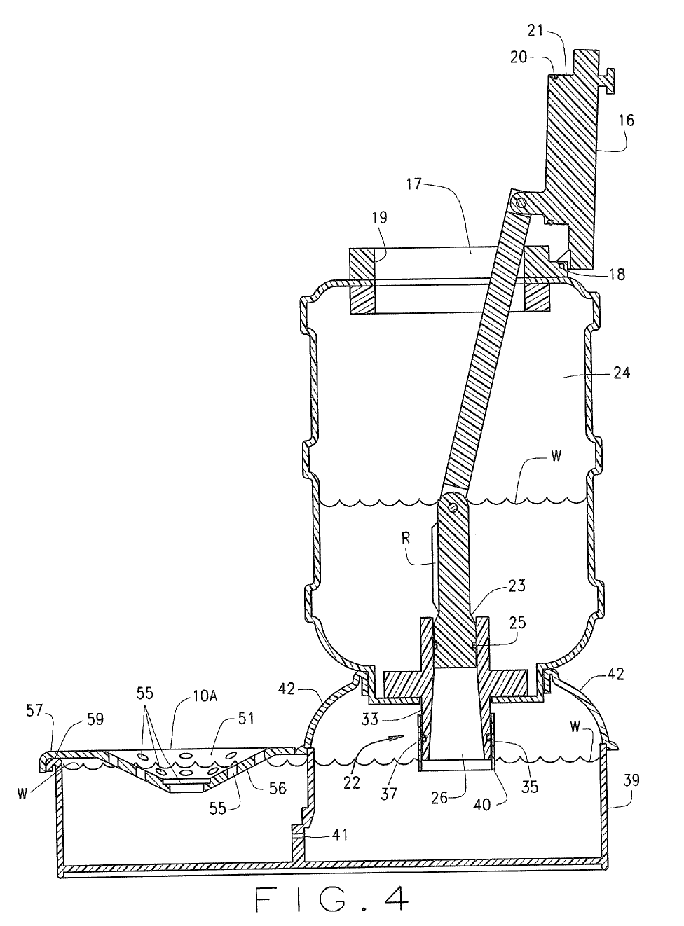

A pet watering device is designated generally 1 and includes a container 2 adapted for containing water W in bulk, FIGS. 3, 4, and for dispensing from a container bottom portion 4 into a dispensing tray arrangement 6 having an upwardly opening drinking bowl portion 8. In a preferred embodiment, an insert 10 can be provided in the bowl 8 having an elevated lapping surface 11 that provides access to water in the bowl 8 while limiting the amount of movement of the pet's muzzle into the water in the bowl 8.

The container 2 is preferably in the form of a jar having a body portion 12 adapted to store a quantity of water W as for example one to two gallons of water. The container 2 is removably mounted to the tray arrangement 6. The container 2 has a sidewall 13 and opposite ends 14, 15. The container 2 has a pair of flow control devices 7, 9 linked together for simultaneous operation. The flow control device 7 includes a cap 16 provided on the end 14 to selectively seal a filling opening 17. As shown, the cap 16 is hingedly mounted to the body 12 preferably on the end 14 with a hinge structure 18 and functions as a valve element to seal the opening 17 when the cap 16 is in a closed position. A valve seat 19 is provided for selective sealing engagement with a seal member 20 such as an O-ring mounted to the cap 16. When the cap 16 is in the open position, FIG. 4, water may be poured through the filling opening 17 to fill the jar thereby eliminating the need for removing the container 2 from the tray arrangement 6 for filling. Having the container 2 removably mounted to the tray 6 permits easy cleaning of the tray 6 and container 2. A generally cylindrical surface forms the valve seat 19, as shown, for sealing engagement with the seal 20 of the valve element cap 16. The seal 20 circumscribes a generally cylindrical projection 21 that fits inside the valve seat 19. Other sealing arrangements could be used, for example, the valve seat 19 can be part of the cap 16 and the seal 20 can be mounted to the cap structure on the end 14.

If a filling opening 17 was provided for a prior art container construction and opened while the container was in a dispensing orientation, water contained in the container 2 would drain out the discharge 22 thereof and overflow the bowl 8. The discharge 22, in the embodiment shown, is in the form of a tube having an interior discharge flow channel 26. The flow control device 9 includes a valve element 23 positioned in the discharge channel 26 to form a valve to prevent water from draining from the container 2 when the filling opening 17 is open and provides for flow of air into the interior storage chamber 24 of the container 2 and water out of the container 2 when the filling opening 17 is closed. As seen, the valve 23 is in the form of a plug with a seal element 25, for example, an O-ring seal that seals to an interior surface defining the flow channel 26 in the discharge 22.

The valve 23 is operatively associated with the cap 16 to automatically and simultaneously close the valve 23 when the cap 16 is moved to an open position. Preferably, the connection of the valve 23 to the cap 16 is mechanical. In the illustrated embodiment, a relatively rigid link 27 connects the cap 16 to the valve 23 effecting simultaneous positive joint movement of the cap 16 and valve 23 element for both opening and closing movements. In the illustrated structure, the link 27 is connected to the cap 16 through a clevis type hinge arrangement at 18 and a clevis hinge arrangement at 30 between the link 27 and valve element 23. The valve element 23 is provided with flow passages 32, formed by spaced apart ribs R on the valve element 23, upstream of a seal 25 that will allow a portion of the valve 23 with the seal 25 to move out of sealing engagement with the discharge 22, FIG. 3, to permit flow through the flow passages 32 when the cap 16 is in the closed condition. When the cap 16 is moved to the open position, the valve 23 moves upwardly bringing the seal 25 into sealing engagement with both a portion of the valve element 23 and the interior surface of the discharge 22, FIG. 4.

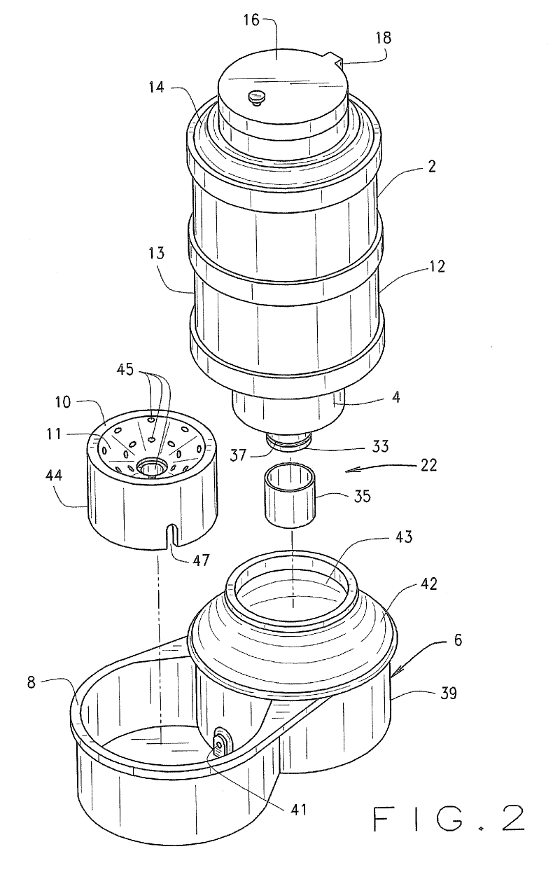

In the illustrated structure, the discharge 22 is provided with a water level adjustment device for controlling, in an adjustable manner, the normal level of water in the bowl 8. As shown in FIGS. 2-4, the discharge 22 has a generally cylindrical exterior surface 33. A selectively movable spout member 35 is movably mounted on the discharge 22 in a sealed relationship as with an O-ring seal 37 mounted to the exterior of the discharge 22. By moving the spout 35 longitudinally of the discharge 22, the free end 40 of the spout 35 is adjustable relative to the interior of the water basin 39 of the tray arrangement 6 that first receives water from the container 2 for subsequent discharge to the bowl 8. By adjusting the end of the spout 35 relative to the tray arrangement 6, the level of water can be adjusted in the bowl 8 to any desired level within the range of movement of the end 40 of spout 35. As seen, a port 41 is provided to provide flow communication between the interior of the basin 39 and the interior of the bowl 8. The basin 39 is provided with cover 42 removably mounted on an upper portion of the basin. The cover has an opening 43 for receiving the bottom portion 4 of the container 2 thereon for removable mounting.

An insert 10, as best seen in FIGS. 2, 3, is positioned within the interior of the bowl 8. The insert 10 provides an elevated drinking surface 11 that positively limits movement of a pet's muzzle into the interior of the bowl 8 providing a muzzle guard. In the illustrated structure, the insert 10 has a normally upwardly facing surface 11 that is generally concave and preferably has a portion thereof above and a portion below the normal water level. At least one water flow path 45 is provided to allow water to come up into the area of the surface 11 from below. The insert 10 has a sidewall 44 that elevates the surface 11 within the interior of the bowl 8 and can be provided with notches 47 to allow water to flow from the bowl 8 into the interior of the insert 10 and up through one or more flow paths 45. The insert 10 preferably has a density greater than water whereby it rests on a bottom wall 46 of the bowl 8. The level of water on the surface 11 can be adjusted by adjusting the position of the spout 35 on the discharge 22. As shown, there are provided a plurality of flow paths 45 positioned in spaced apart relationship about the surface 11 at desired locations. Preferably, the insert 10 is easily removable from the bowl 8 both for cleaning or removal from the bowl in the event its use is not desired. The level of water on the surface 11 is automatically maintained with the level of the water in the bowl 8.

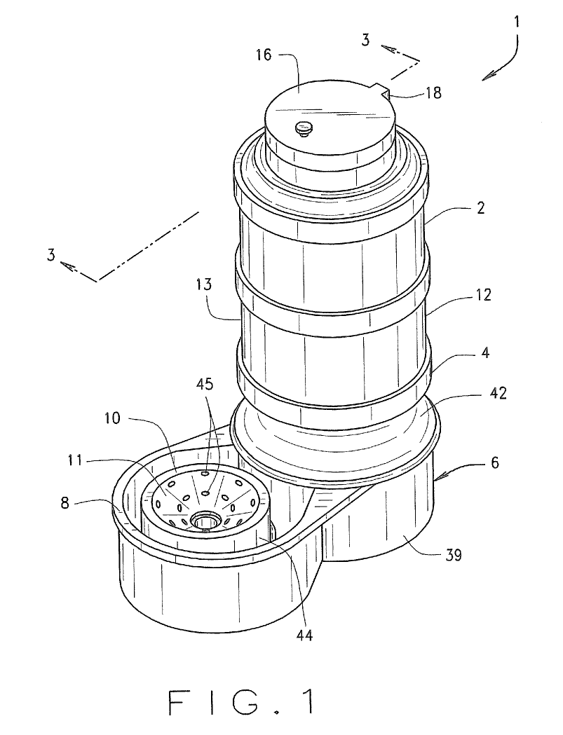

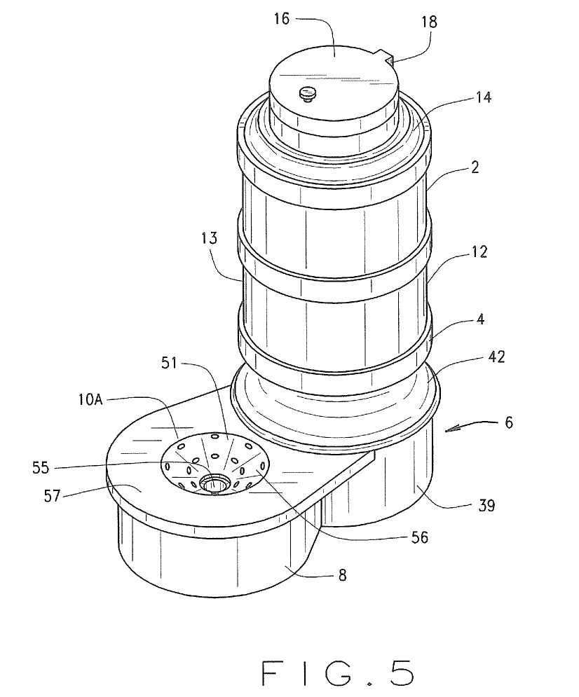

FIGS. 4, 5 show an alternative embodiment for the illustrated insert 10 of FIGS. 1-3. The alternative insert 10A has a normally upwardly facing surface 51 that is generally concave and preferably has a portion thereof above and a portion below the normal water level in the bowl 8. There is at least one water flow path 55 to allow water to come up into the area of the surface 51 from below. As seen, the flow path 55 is a centrally positioned opening through a wall 56 forming the concave surface 51. The insert 10A has a peripheral portion 57 sized and shaped to rest on an upper surface 59 of the bowl 8 to elevate the surface 51 within the interior of the bowl 8. The wall 56, as shown, projects radially outwardly from the central most flow path 55 to the peripheral portion 57. The insert 10A may be conveniently formed as by injection molding or vacuum forming and is preferably made of a polymeric material. In a preferred embodiment, the insert 10A is removably mounted on the tray arrangement 6 to partially close a bowl opening 60. The insert 10A may be provided with means, for example, break off tabs that would permit height adjustment of the surface 51 relative to the level of water W in the bowl 8. The insert 10A is easily removable from the bowl 8 for both cleaning and removal from the bowl in the event its use is not desired. The level of water W on the surface 51 may also be adjusted as described above using the spout 35. The wall 56 provides a muzzle guard and positively limits the movement of a pet's muzzle into the bowl 8 for drinking. The surfaces 51 and 11 extend across a substantial portion of the area of the opening into the bowl 8, e.g., at least about ⅓ and preferably at least about ½ of the area of the bowl opening.

In a preferred embodiment, the various components of the device 1 are molded. The container 2 may be blow molded, the tray arrangement 6 may be injection molded and the insert 10 may also be injection molded. The cap 5, discharge 22 and valve 23 may also be injection molded. Preferably, the container 2 is formed from a transparent polymer so that one may view the contents of the container 2 to determine whether or not it needs to be filled. In operation, to fill the container 2, the cap 16 is moved to an open position providing access to the filling opening 17. Water may be dispensed into the container 2 without the need for removal of the container 2 from the tray arrangement 6. Upon transferring the desired amount of water to the container 2, the cap 16 is moved to its closed position which allows the valve element 23 to move to an open position for controlled discharge of water from the container 2 to the basin 39 and bowl 8. The container 2 does not need to be removed to effect the addition of water. However, it may be easily removed for cleaning or maintenance by opening the cap 16 to prevent water drainage out of the discharge 22.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations, and other uses and applications of the present constriction will, however, become apparent to those skilled in the art after considering the specification and the accompanying drawings.

1. An automatic pet watering device comprising:
a dispensing tray arrangement having an upwardly opening bowl and a basin in flow communication with the bowl;
a container removably mounted to the dispensing tray arrangement and having an outlet positioned in the basin and having a filling open, said outlet being positioned to automatically maintain a predetermined level of water in the bowl; and
first and second flow control devices operably associated with each other and the container with the first flow control device being operable to selectively open and close the outlet and the second flow control device being operable to selectively provide filling access to a storage compartment in an interior of the container, said first and second flow control devices being linked whereby when the second flow control device is closed, the first flow control device is simultaneously opened for dispensing water to the bowl and when the second flow control device is open for adding water to the storage compartment, the first flow control device is simultaneously closed preventing flow of water from the outlet.

2. The pet watering device of claim 1 wherein the first and second flow control devices being linked by a mechanical link operably associated with each of the first and second flow control devices.

3. The pet watering device of claim 2 wherein the second flow control device including a cap movably carried by the container and a first valve seat mounted on the container adjacent the filling opening, said cap being selectively engageable with the valve seat to close said filling opening.

4. The pet watering device of claim 2 wherein the cap being pivotally carried by the container.

5. The pet watering device of claim 4 where in the cap including a seal member engageable with a first valve seat to help effect closing of the filling opening.

6. The pet watering device of claim 2 wherein the second flow control device including a valve element and a second valve seat engageable with a portion of the valve element to selectively effect closing of the outlet when the filling opening is open.

7. The pet watering device of claim 6 wherein the second valve seat including a surface at least partially defining the outlet and the valve element being linked to the first flow control device.

8. The pet watering device of claim 7 wherein the valve seat including an interior surface of a discharge member, said valve member being movably received within the discharge member.

9. The pet watering device of claim 8 wherein the cap being pivotally carried by the container.

10. The pet watering device of claim 1 including a spout movably mounted on the second flow control device and extending in the basin and being adjustable in spacing from a bottom of the basin for adjusting water level in the basin.

11. The pet watering device of claim 1 including an insert positioned in the bowl and having a generally upwardly facing surface positioned above a bottom surface of the bowl, said upwardly facing surface having at least a portion thereof below a normal level of water in the bowl.

12. The pet watering device of claim 11 wherein the insert including at least one flow path to provide flow communication between a storage compartment of the bowl and the upwardly facing surface of the insert.

13. The pet watering device of claim 12 wherein the upwardly facing surface is generally concave.

14. A pet watering device comprising:
a dispensing tray arrangement including a basin and a bowl said basin connected in flow communication with the bowl;
a water container in flow communication with the basin; and
an insert having at least a drinking surface thereof positioned in said bowl, at least a portion of said surface being positioned below a level so that water in the bowl will be above the drinking surface, said insert having at least one flow passage to provide water from the bowl to at least partially overlie the drinking surface.

15. The pet watering device of claim 14 wherein the insert being removably mounted to the tray arrangement.

16. The pet watering device of 15 wherein the insert having a sidewall with a lower end resting on a bottom wall of the bowl.

17. The pet watering device of claim 15 wherein the insert having a peripheral portion resting on an upper portion of the bowl.

18. The pet watering device of claim 15 wherein the drinking surface being generally upwardly facing and being generally concave.

19. The pet watering device of claim 18 wherein at least one said flow passage being positioned adjacent a central portion of the concave portion of said surface.

20. The pet watering device of claim 14 including means associated with the container for adjusting water level in the bowl.

21. The pet watering device of claim 20 wherein the means including a spout member movably mounted on a discharge member of the container.

22. The pet watering device of claim 21 including at least two flow control devices operably associated with each other whereby opening of a first flow control device effecting simultaneous closing of a second flow control device.
